(19) United States
(12) Patent Application Publication
(10) Pub. No.: US 2007/0003909 A1
(43) Pub. Date: Jan. 4, 2007

(54) Method and drill bit for extracting a root of a tooth

(76) Inventor: Benno Syfrig, Luzern (CH)

Correspondence Address: BRIAN ROFFE, ESQ, 11 SUNRISE PLAZA, SUITE 303, VALLEY STREAM, NY, 11580-6111, US

(21) Appl. No.: 10/596,625

(22) PCT Filed: Dec. 4, 2004
(86) PCT No.: PCT/EP04/13821

§ 371 Date: Jun. 19, 2006

(30) Foreign Application Priority Data
Dec. 23, 2003 (CH) 02213/03

(51) Int. Cl. A61C 5/02; A61C 3/02

(52) U.S. Cl. 433/224; 433/165

(57) ABSTRACT

In order to extract a root of a tooth, this root (12) is drilled by a pin projection (8), which has a smaller diameter and is coated with an abrasive material. Afterwards, a threaded pin is inserted by rotation into the opening in the tooth made by the pin projection. As a result, the threaded pin whose upper part is provided with a lug is sufficiently anchored whereby enabling an extraction in the longitudinal direction of the tooth to be reliably carried out.

The invention relates to a method to extract a root of a tooth in which the upper part of the root is drilled into by a drill, and to a drill.

The extraction of the root of a tooth is linked with problems in cases where the crown is broken off or the root is not free for other reasons, so that there is no access remaining for pincers or similar. In this case a hole is drilled into the root section in the longitudinal direction of the tooth and a screw is screwed into this. The root of the tooth is then extracted with the lug of the screw by pulling in the longitudinal direction of the tooth. In such a case there is the risk that the alveole will be damaged and this will necessitate a corresponding crest augmentation.

A device of this type is prior art, for example, from DE 19 815 133. The disadvantage, however, is that a hole in the root has to be drilled step by step by using several drills of increasing diameter. The depth of penetration of such a hole is also limited since the tooth has a conical form. This in turn allows only the use of a relatively short traction screw for the extraction . Such relatively short traction screws have only limited anchorage in the tooth material.

The invention is intended to solve the problem of creating a method and a drill with which the aforementioned disadvantages can be avoided and thus enable a safe and simple extraction of the root of a tooth.

The inventive method is characterised in that the root of a tooth is expanded by a drill which is coated, at least on its tip, with an abrasive material, and thereafter a threaded pin can be inserted by rotation into the opening thus created in the root,

The inventive drill to realise the method is characterised in that the drill part, at its forward end, is provided with a pin projection, preferably of smaller diameter and approximately cylindrical, which is coated with an abrasive material at its tip and on the cylindrical sheath,

In the inventive method, the root of a tooth is drilled in one working cycle. Compared with the drill intended for the upper part of the root, a smaller diameter is available for the lower root canal in the form of a pin projection with an abrasive surface.

This makes it possible to create an opening in a part of the root which can extend almost to the lower end of the root of a tooth. In this area, the tooth material has been found to be very compact. As the result of this, the threaded pin penetrating into this deepest root opening finds a good anchorage for the extraction. This method also achieves maximum protection of the alveole.

A further advantage which distinguishes this inventive drill is that one may drill independently of the anatomical root canal. Even if this root canal is often closed by calcification, by a broken drill or similar, the desired hole can be made using the drill in any position of the root, even if the remaining root is only small.

Embodiments of the invention and further advantages thereof are next explained in more detail with the aid of the drawings, which show:

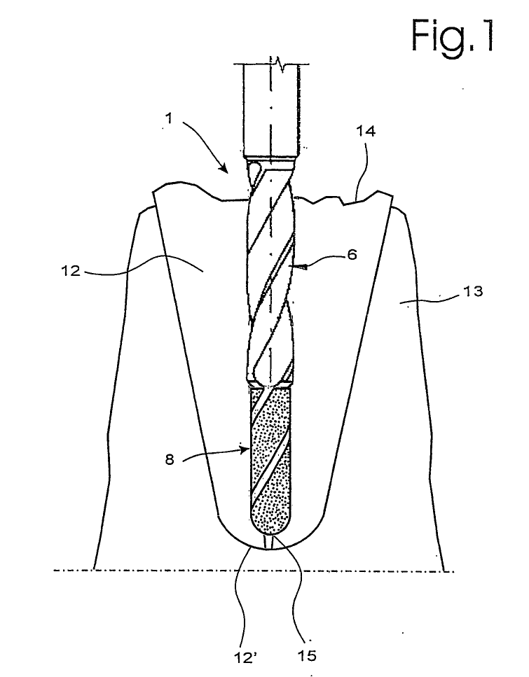

FIG. 1 shows a schematic section of an inventive drill when drilling into a root of a tooth, and

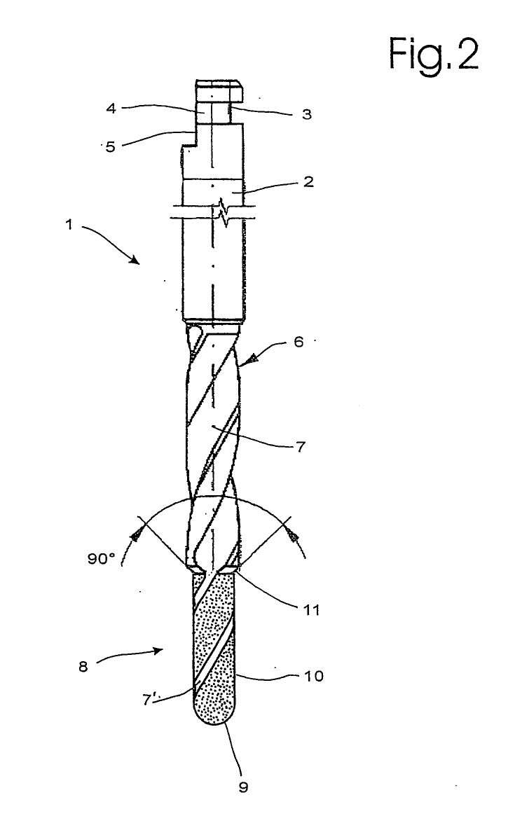

FIG. 2 the drill according to FIG. 1 in lateral view.

FIG. 1 shows, schematically and greatly enlarged, a root 12 of a broken tooth held by a surrounding gm 13 with a break point 14. A drill 1 drilled into this tooth root 12 is shown here, which is next explained in more detail.

According to FIG. 2, the inventive steel drill 1 includes a cylindrical shaft part 2, which ends at the top in a head part 3. In the embodiment shown, the head part 3 is provided with an annular groove 4 and a lateral, smooth, milled recess 5 as means of rotatably connecting mounting in a drill device. Depending on the drilling tool to be used, the shape of the head may also be of a different design.

A drill 6 is joined to the shaft part 2. The drill is provided with helical grooves 7 and designed as a self-tapping drill tool.

According to the invention, a cylindrical pin projection 8 is integrally attached to the lower end of the drill part 6. Since the pin projection 8 has a lesser diameter than the drill part, there is a taper 11 at the transition with an angle of some 90°. There are also helical grooves 7′ extending as far as those of the drill part 6. The tip 9 of the pin projection is hemispherical or convex or similar in form. This hemispherical shape makes it possible for the drill to cut practically to its tip and thus makes drilling easier. As a rule, there is a very narrow hole 15 in the root of a tooth 12, into which the pin projection 8 can be guided. The pin projection 8, together with its hemispherical tip 9, is coated with an abrasive surface, whereby the abrasive material preferably consists of diamond dust.

The length of the drill part 6 together with cylindrical pin projection 8 is 15-18 mm, preferably about 16 mm. The cylindrical pin projection 8 has a length of 5-8 mm, preferably about 6 mm. The drill part has a diameter of about 2 mm and the diameter of the pin projection is 1.3 to 1.6 mm, preferably 1.4 mm,

A tool attached to the head part 3 allows a connection with a rotary driver with which the drilling operation can be realised.

When drilling the root of a tooth 12 the drill 1 is drilled in approximately to a depth as shown in FIG. 1—so that the pin projection 8 of the drill 1 comes to rest in the lower part, near to the base 12′ of the root 12, i.e. that there still remain a maximum of a few millimetres from the tip of the projection g to the root end. With this drill, a further advantage is guaranteed, in that the drill dust generated when drilling with the projection 8 is carried away by the helical grooves 7, 7′ of the drill part 6, advantageously also extending along the pin projection 8,

Once the drilling operation is complete, i.e. the pin projection 8 has reached the planned depth, the drill is withdrawn from the root and a threaded pin inserted into the opening, which is not shown in more detail. The tip of this threaded pin thereby engages with several windings in the wall of the opening created by the pin projection 8. The upper part of the threaded pin thereby presses against the wall of the opening created by the drill in the root or engages therein.

The extraction of the root takes place hereafter with the aid of a tool inserted in the mouth. This can either be a pincer-type tool, in which case the one leg is linked by a joining member with the threaded pin provided with a lug, or in another variant it can be realised by the use of a manually-operated tension device, partially inserted into the mouth. The head of the threaded pin is then connected via a traction cable or similar with one slide of the tension device. By rotating a screw, the slide can move linearly and a traction force in the longitudinal direction of the tooth is exerted via the threaded pin for the extraction of the root.

In the case of teeth with multiple roots, it may be useful to split such a tooth and to extract the individual root parts in the way described heretofore.

The invention is sufficiently disclosed with the embodiments explained above. It could, however, also be illustrated in other variants. In principle, the whole drill could be made from abrasive material, as is the case here with the pin projection. The front pin projection may also advantageously be provided with one or more helical grooves 7′.

1. Method to extract a root of a tooth, whereby the upper part of the root of a tooth (12) is drilled into by a drill (1), characterised in that the drill (1) expanding the root (12) is coated, at least on its tip (9), with an abrasive material, through which the root is drilled at least to close to its base (12′), and after removal of the drill (1) a threaded pin can be inserted by rotation into the opening in the root (12).

2. Method according to claim 1, characterised in that the root (12) is expanded by a pin projection (8) which is coated with an abrasive material and has a smaller diameter than a boring drill part (6).

3. Drill to extract roots of teeth to execute the methods according to claim 1, with a boring drill part (6) and a shaft (2), the head (3) of which is provided with means for a rotatably connecting mounting in a drill device, characterised in that the drill part (6) is provided with a pin projection (8) at its forward end, preferably of smaller diameter and approximately cylindrical, which is coated with an abrasive material (10) at its tip (9) and on the cylindrical sheath.

4. Drill according to claim 3, characterised in that the cylindrical pin projection (8) has a length of between 5 and 8 mm and a diameter of 1.3 to 1.6 mm.

5. Drill according to claim 3, characterised in that the pin projection (8) has a length of at least approximately 6 mm and a diameter of at least approximately 1.3 mm.

6. Drill according to claim 3, characterised in that the abrasive material of the pin projection (8) consists essentially of diamond dust.

7. Drill according to claim 3, characterised in that the pin projection (8) is rounded at its abrasive tip and there is a taper (11) at the transition from the drill part (6) to the projection (8).

8. Drill according to claim 3, characterised in that the diameter of the drill part (6) is at least approximately 2 mm and the total length of the drill part (6) together with pin projection (8) is at least approximately 16 mm.

9. Drill according to claim 3, characterised in that the drill part (6) is in the form of a self-tapping screw.

10. Drill according to claim 3, characterised in that the drill part (6) has at least one helical groove (7) carrying away the drilled material and the pin projection (8) has at least one helical groove (7′) extending to that on the drill part (6).
